(19) United States
(12) Patent Application Publication
(10) Pub. No.: US 2014/0074765 A1
(43) Pub. Date: Mar. 13, 2014

(54) DECISION FOREST GENERATION

(71) Applicant: Harald Steck, Campbell, CA (US)

(72) Inventor: Harald Steck, Campbell, CA (US)

(21) Appl. No.: 13/606,347

(22) Filed: Sep. 7, 2012

(51) Int. Cl. G06N 7/02

(52) U.S. Cl. 706/52

(57) ABSTRACT

An exemplary method of establishing a decision tree includes determining an effectiveness indicator for each of a plurality of input features. The effectiveness indicators each correspond to a split on the corresponding input feature. One of the input features is selected as a split variable for the split. The selection is made using a weighted random selection that is weighted according to the determined effectiveness indicators.

### BACKGROUND

Decision trees have been found to be useful for a variety of information processing techniques. Sometimes multiple decision trees are included within a random decision forest.

One technique for establishing decision trees, whether they are used individually or within a decision forest, includes growing the decision trees based upon random subspaces. Deciding how to configure the decision tree includes deciding how to arrange each node or split between the root node and the terminal or leaf nodes. One technique for managing the task of establishing splits within a decision tree when there are a significant number of variables or input features includes using random subspaces. That known technique includes selecting a random subset or subspace of the input features at each node. The members of the random subset are then compared to determine which of them provides the best split at that node. The best input feature of that random subset is selected for the split at that node.

While the random subset technique provides efficiencies especially in high dimensional data sets, it is not without limitations. For example, randomly selecting the members of the random subsets can yield a subset that does not contain any input features that would provide a meaningful or useful result when the split occurs on that input feature. The randomness of the random subset approach might avoid this situation occurring throughout a decision forest.

### SUMMARY

An exemplary method of establishing a decision tree might include determining an effectiveness indicator for each of a plurality of input features. The effectiveness indicators might each correspond to effectiveness or usefulness of a split on the corresponding input feature. One of the input features may be selected as a split variable for the split. The selection is made using a weighted random selection that is weighted according to the determined effectiveness indicators.

An exemplary device that establishes a decision tree might include a processor and digital data storage associated with the processor. The processor may be configured to use at least instructions or information in the digital data storage to determine the effectiveness indicator for each of a plurality of input features. The effectiveness indicators may each correspond to an effectiveness or usefulness of a split on the corresponding input feature. The processor may also configured to select one of the input features as a split variable for the split using a weighted random selection that is weighted according to the determined effectiveness indicators.

Other examplary embodiments will become apparent to those skilled in the art from the following detailed description. The drawings that accompany the detailed description can be briefly described as follows.

### BRIEF DESCRIPTION OF THE DRAWINGS

FIG. 1 schematically illustrates a random decision forest including a plurality of decision trees and a device for establishing and using the decision forest.

FIG. 2 is a flow chart diagram summarizing an example approach for establishing a decision tree within a decision forest like that shown schematically in FIG. 1.

FIG. 3 schematically illustrates portions of a process of establishing a decision forest.

### DETAILED DESCRIPTION

The disclosed techniques are useful for establishing a decision forest including a plurality of decision trees that collectively yield a desired quality of information processing results even when there are a very large number of variables that must be taken into consideration during the processing task. The disclosed techniques facilitate achieving variety among the decision trees within the forest. This is accomplished by introducing a unique, weighted or controlled randomness into the process of establishing the decision trees within the forest. The resulting decision forest includes a significant number of decision trees that have an acceptable likelihood of contributing meaningful results during the information processing.

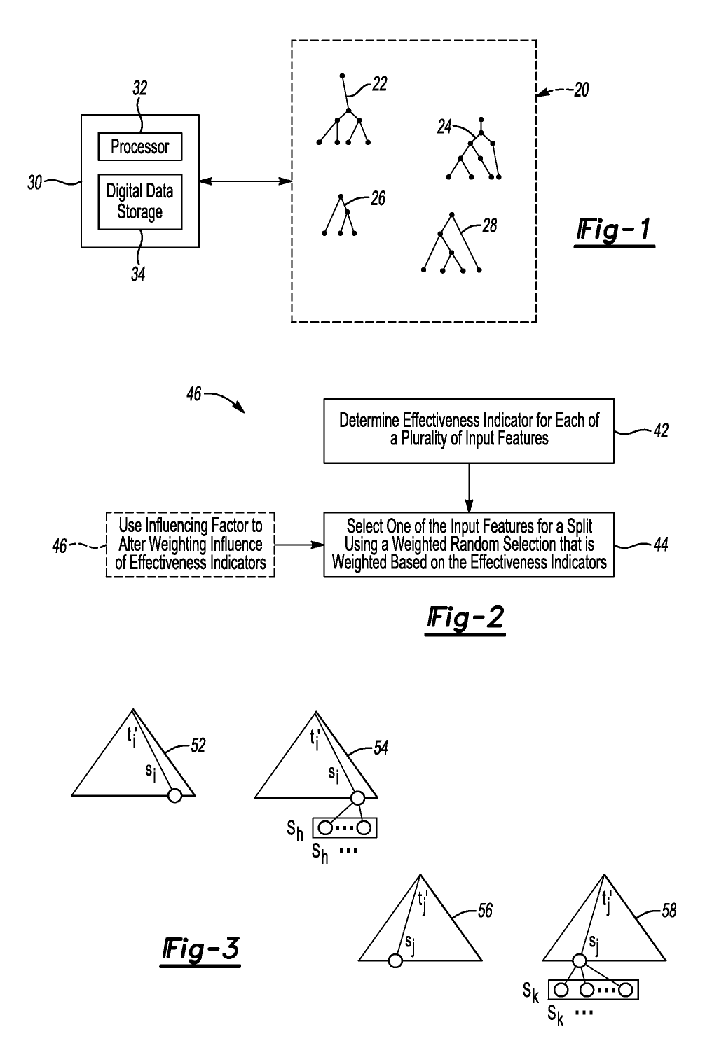

FIG. 1 schematically illustrates a random decision forest 20. A plurality of decision trees 22, 24, 26 and 28 are shown within the forest 20. There will be many more decision trees in a typical random decision forest. Only a selected number of trees are illustrated for discussion purposes. As can be appreciated from FIG. 1, the decision trees are different than each other in at least one respect.

A device 30 includes a processor 32 and associated digital data storage 34. The device 30 is used in this example for establishing trees within the random decision forest 20. The device 30 in some examples is also configured for utilizing the random decision forest for a particular information processing task. In this example, the digital data storage 34 contains information regarding the input features or variables used for decision-making, information regarding any trees within the forest 20, and instructions executed by the processor 32 for establishing decision trees within the forest 20.

In some examples, the random decision forest 20 is based upon a high dimensional data set that includes a large number of input features or variables. Some examples may include more than 10,000 input features. A high dimensional data set presents challenges when attempting to establish the decision trees within the forest 20.

The illustrated example device 30 utilizes a technique for establishing or growing decision trees that is summarized in the flow chart 40 of FIG. 2. As shown at 42, the processor 32 determines an effectiveness indicator for each of the plurality of input features for a split under consideration. The effectiveness indicator for each of the input features corresponds to an effectiveness or usefulness of a split on that input feature. In other words, the effectiveness indicator provides an indication of the quality of a split on that input feature. The quality of the split corresponds to the quality of resulting information. Higher quality corresponds to more meaningful progress or results during the information processing task.

In one example, the effectiveness indicator corresponds to a probability or marginal likelihood that the split on that input feature will provide a useful result or stage in a decision making process.

In one particular example, the effectiveness indicator is determined based upon a posterior probability or marginal likelihood, assuming uniformity of the tree prior to any of the splits under consideration. A known Bayesian approach based on the known Dirichlet prior, including an approximation in terms of the Bayesian information criterion, is used in one such example. Those skilled in the art who have the benefit of this description will understand how to apply those known techniques to realize a set of effectiveness indicators for a set of input features where those effectiveness indicators correspond to the posterior probability that a split on each value will provide meaningful or useful results.

One example includes using information gain criteria, which is a known split criteria for decision trees. The information gain criteria provides an indication of how valuable a particular split on a particular input feature will be.

FIG. 3 schematically represents example potential trees 52, 54, 56 and 58 in a state where the trees are still being established or trained. In this example the potential decision tree 54 represents a potential split of Sₕ into the values sₕ, . . . . Determining the effectiveness indicators for the potential split shown on the tree 54 in one example includes determining the marginal likelihood p(D|t₅₄). One technique for determining the effectiveness indicator includes determining a marginal likelihood ratio of the tree in the stage shown at 54 compared to the tree 52. The marginal likelihood ratio can be represented as p(D|t₅₄)/p(D|t₅₂), which is a value that can be computed locally. That marginal likelihood ratio may be compared to other marginal likelihood ratios for alternative splits using the tree 52 as the base or prior tree. Each marginal likelihood ratio provides an effectiveness indicator in one example. Comparing the marginal likelihood ratios provides an indication of the comparative value or usefulness for each of the splits under consideration.

Similarly, the tree 58 represents potential splits of Sₖ into the values sₖ, . . . . The marginal likelihood ratio for the tree 58 (i.e., p(D|t₅₈)) may also be calculated and used as a effectiveness indicator.

In one example, the trees 52 and 56 are the same even though the paths involved in the local calculation of the likelihood ratios are different. In such an example, the marginal likelihood ratio p(D|t₅₈)/p(D|t₅₆) for the split shown on the tree 58 may be compared to the marginal likelihood ratio p(D|t₅₄)/p(D|t₅₂) for the split on the tree 54.

Locally comparing two trees allows for comparing all possible trees with each other in terms of their posterior probabilities or, alternatively, their marginal likelihoods. One can construct the sequence of trees between any two trees that includes neighboring trees in the sequence differing only by a single split. In other words, taking the example approach allows for relating the overall marginal likelihood of a tree to the local scores regarding each individual split node.

Adding one split at a time allows for comparing all possible splits to the current tree (i.e., the tree before any of the possible splits under consideration is added). According to the disclosed example, the various splits can be compared to each other in terms of marginal likelihood ratios and each of the marginal likelihood ratios can be evaluated locally. The illustrated example includes determining a effectiveness indicator for every input feature that is a potential candidate for a split on a tree within the forest 20.

As shown at 44 in FIG. 2, one of the input features is selected for the split using a weighted random selection. This example includes randomly selecting an input feature as the split node and weighting that selection based upon the effectiveness indicators for the input features. One example includes using a probability of randomly selecting an input feature that is proportional to the marginal likelihood ratio of that input feature. In other words, the weighted random selection includes an increased likelihood of selecting a first one of the input features over a second one of the input features when the effectiveness indicator of the first one of the input features is higher than the effectiveness indicator of the second one of the input features. Stated another way, an input feature that has a higher marginal likelihood ratio has a higher likelihood of being selected during the weighted random selection process.

In one example, the selection of the input feature for some splits does not include all of the input features within the weighted random selection process. One example includes using the effectiveness indicators and a selected threshold for reducing the number of input features that may be selected during the weighted random selection process for some splits. For example, some of the input features will have a marginal likelihood ratio that is so low that the input feature would not provide any meaningful information if it were used for a particular split. Such input features may be excluded from the weighted random selection. The weighted random selection for other splits includes all of the input features as candidate split variables.

The example of FIG. 2 includes an optional feature shown at 46. In some examples, an influencing factor is utilized for altering the weighting influence of the effectiveness indicators. An influencing factor in some examples reduces the distinction between the effectiveness indicators for reducing any difference in the probability that one of the input features will be selected over another based on the corresponding input values.

In one example, the influencing factor is selected to introduce additional randomness in the process of establishing decision trees.

In one example, the influencing factor corresponds to a sampling temperature T. When the value of T is set to T=1, that has the same effect as if no influencing factor is applied. The effectiveness indicators for the input features affect the likelihood of each input feature being selected during the weighted random selection. As the temperature T is increased to values greater than one, the Boltzmann distribution, which corresponds to the probability of growing a current tree to a new tree with an additional split on a particular input feature, becomes increasing wider. The more that the value of T increases, the less the effectiveness indicators influence the weighted random selection. As the value of T approaches infinity, the distribution becomes more uniform and each potential split is sampled with an equal probability. Utilizing an influencing factor during the weighted random selection process provides a mechanism for introducing additional randomness into the tree establishment process.

One feature of utilizing an influencing factor for introducing additional randomness is that it may contribute to escaping local optima when learning trees in a myopic way, where splits are added sequentially. Accepting a split that has a low likelihood can be beneficial when it opens the way for a better split later so that the overall likelihood of the entire tree is increased. The problem of local optima may become more severe when using only the input features that have the highest effectiveness indicators for determining each split. In some instances, that can result in a forest where the trees all are very similar to each other. It can be useful to have a wider variety among the trees and, therefore, introducing additional randomness using an influencing factor can yield a superior forest in at least some instances.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of establishing a decision tree, comprising the steps of:
determining an effectiveness indicator for each of a plurality of input features, the effectiveness indicators each corresponding to a split on the corresponding input feature; and
selecting one of the input features as a split variable for the split using a weighted random selection that is weighted according to the determined effectiveness indicators.

2. The method of claim 1, wherein each effectiveness indicator corresponds to a probability that the split on the input feature will yield a useful determination within the decision tree.

3. The method of claim 1, wherein
the weighted random selection includes increasing a likelihood of selecting a first one of the input features over a second one of the input features; and
the effectiveness indicator of the first one of the input features is higher than the effectiveness indicator of the second one of the input features.

4. The method of claim 3, comprising
weighting the weighted random selection in proportion to the effectiveness indicators.

5. The method of claim 1, comprising
limiting which of the input features are candidates for the selecting by selecting only from among the input features that have a effectiveness indicator that exceeds a threshold.

6. The method of claim 1, comprising
selectively altering an influence that the effectiveness indicators have on the weighted random selection.

7. The method of claim 6, comprising
applying an influencing factor to the effectiveness indicators in a manner that reduces any differences between the effectiveness indicators.

8. The method of claim 1, wherein the plurality of input features comprises all input features that are utilized within a random decision forest that includes the established decision tree.

9. The method of claim 1, comprising performing the determining and the selecting for at least one split in each of a plurality of decision trees within a random decision forest.

10. The method of claim 1, comprising performing the determining and the selecting for each of a plurality of splits in the decision tree.

11. A device that establishes a decision tree, comprising:
a processor and data storage associated with the processor, the processor being configured to use at least one of instructions or information in the data storage to
determine an effectiveness indicator for each of a plurality of input features, the effectiveness indicators each corresponding to a split on the corresponding input feature and
select one of the input features as a split variable for the split using a weighted random selection that is weighted according to the determined effectiveness indicators.

12. The device of claim 11, wherein each effectiveness indicator corresponds to a probability that the split on the input feature will yield a useful determination within the decision tree.

13. The device of claim 11, wherein
the weighted random selection includes an increased likelihood of selecting a first one of the input features over a second one of the input features; and
the effectiveness indicator of the first one of the input features is higher than the effectiveness indicator of the second one of the input features.

14. The device of claim 13, wherein the processor is configured to
weight the weighted random selection in proportion to the effectiveness indicators.

15. The device of claim 11, wherein the processor is configured to
limit which of the input features are candidates to select by selecting only from among the input features that have a effectiveness indicator that exceeds a threshold.

16. The device of claim 11, wherein the processor is configured to
selectively alter an influence that the effectiveness indicators have on the weighted random selection.

17. The device of claim 16, wherein the processor is configured to
apply an influencing factor to the effectiveness indicators in a manner that reduces any differences between the effectiveness indicators.

18. The device of claim 11, wherein the plurality of input features comprises all input features that are utilized within a random decision forest that includes the established decision tree.

19. The device of claim 11, wherein the processor is configured to determine the effectiveness indicators and select one of the input features for at least one split in each of a plurality of decision trees within a random decision forest.

20. The device of claim 11, wherein the processor is configured to determine the effectiveness indicators and select one of the input features for each of a plurality of splits in the decision tree.
